(19) United States
(12) Patent Application Publication
(10) Pub. No.: US 2005/0132599 A1
(43) Pub. Date: Jun. 23, 2005

(54) Drying method of washing machine and apparatus thereof

(75) Inventors: Tae-Hee Lee, Bucheon (KR); Hyun-Seok Seo, Incheon (KR); Byung-Keol Choi, Incheon (KR); Byung-Soo Je, Seoul (KR); Moon-Hee Hong, Seoul (KR); Si-Moon Jeon, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/994,415

(22) Filed: Nov. 23, 2004

(30) Foreign Application Priority Data
Dec. 18, 2003 (KR) 2003-93188
Mar. 11, 2004 (KR) 2004-16650

(51) Int. Cl. F26B 19/00; F26B 13/10

(52) U.S. Cl. 34/549; 34/524

(57) ABSTRACT

A drying method is performed by a washing machine capable of precisely drying laundry and reducing power consumption, and an apparatus thereof. The method comprises: detecting a decrement of a heating value of a heat generating unit of a washing machine during a drying mode; and cutting off power supplied to the heat generating unit when the detected decrement reaches a preset reference decrement.

### BACKGROUND OF THE INVENTION

1. Field of the Invention

The present invention relates to a washing machine, and more particularly, to a drying method of a washing machine and an apparatus thereof.

2. Description of the Conventional Art

Generally, a washing machine is an apparatus for washing laundry by performing not only a washing operation, a rinsing operation, and a dewatering operation but also a drying operation. The washing machine is divided into a pulsator type, an agitation type, a drum type, and etc. based upon a washing method. Hereinafter, a general drum type washing machine will be explained with reference to FIG. 1.

FIG. 1 is a sectional view of a general drum type washing machine.

As shown, the conventional drum type washing machine comprises: a casing 13 having an accommodation space therein; a tub 5 installed in the casing 13 and containing washing water; and a drum 17 rotatably installed in the tub 5.

Hereinafter, the construction of the conventional drum type washing machine will be explained in more detail.

A door 1 for taking laundry into/out of the washing machine is formed at the front surface of the casing 13, and the tub 5 is arranged in the casing 13 to extend along a back and forth direction of the casing 13. A supporting spring 7 and a damper 16 for shock-absorbingly supporting the tub 5 are respectively coupled to the upper side and the lower side of the tub 5. A detergent supplying unit 4 for supplying detergent is installed at the front upper side of the tub 5, and a water supply pipe 9 for supplying water is connected to the detergent supplying unit 4.

A drum driving motor 12 for rotating the drum 17 is installed at the rear surface of the tub 5, and a drain pipe 15 having a drain pump 14 is installed at the lower portion of the tub 5. One end of a condensation duct 11 is connected to the rear lower portion of the tub 5 to draw air out of the tub 5, and another end of the condensation duct 11 extends upwardly.

A condensate water supply pipe 10 for supplying condensate water into the condensation duct 11 is provided at the condensation duct 11. A fan 8 for drawing the air inside the tub 5 out and thereby creating air circulation is installed at the upper end of the condensation duct 11. One end of a circulation duct 3 is connected to an outlet of the fan 8 to circulate the air that has passed through the condensation duct 11 into the tub 5. Also, another end of the circulation duct 3 is connected to the front upper portion of the tub 5.

A heater 6 for heating the flowing air is installed in the circulation duct 3, and a temperature sensor 2 for detecting an air temperature is installed at the lower portion of the heater 6.

In the conventional drum type washing machine, a timer (not shown) for setting a drying time to perform a drying operation is provided. That is, a user selectively and subjectively adjusts the timer to set a drying time at the time of performing a drying operation. However, in case that the set drying time is relatively short, laundry is not sufficiently dried. On the contrary, in case that the set drying time is relatively long, an entire washing time is delayed and thus a power of the washing machine is wasted.

In a washing machine according to another conventional technique, a dryness degree sensor (not shown) for detecting a dryness degree of laundry is installed. However, by installing the dryness degree sensor, a fabrication cost of the washing machine is increased. Also, there is a problem that the dryness degree sensor can not precisely detect a dryness degree of laundry when an amount of laundry introduced into the drum 17 is low.

Details of the conventional washing machine are disclosed in the specifications of U.S. Pat. Nos. 6,615,619 and 6,612,138.

### SUMMARY OF THE INVENTION

Therefore, an object of the present invention is to provide a drying method of a washing machine capable of precisely drying laundry without installing a sensor for measuring a dryness degree and capable of reducing a power consumption, and an apparatus thereof.

To achieve these and other advantages and in accordance with the purpose of the present invention, as embodied and broadly described herein, there is provided a drying method of a washing machine comprising: drying laundry with a heater installed in the washing machine during a drying mode; detecting a decrement of a heating value of the heater; and cutting off power supplied to the heater when the detected decrement reaches a preset reference decrement.

In another aspect of the present invention, there is provided a drying method of a washing machine: detecting a temperature by a temperature sensor inside a washing machine when the washing machine is in a drying mode; maintaining an inner temperature of the washing machine at a preset temperature by a heater based on the detected temperature; detecting a decrement of a heating value of the heater; and cutting off power supplied to the heater when the detected decrement is more than a preset reference decrement, the preset reference decrement corresponding to a drying rate goal.

To achieve these and other advantages and in accordance with the purpose of the present invention, as embodied and broadly described herein, there is also provided a drying apparatus of a washing machine comprising a decrement detecting unit for detecting a decrement of a heating value of a heater installed in a washing machine and a control unit for controlling a heating value of the heater such that an inner temperature of the washing machine is maintained at a preset temperature based on a temperature detected by a temperature sensor installed in the washing machine. The control unit cuts off power supplied to the heater when a decrement of the heating value reaches a preset reference decrement.

In another aspect of the present invention, there is provided a drying apparatus of a washing machine comprising: a detection unit for detecting a decrement of a heating value of a heat generating unit of a washing machine; and a control unit for controlling the heating value such that an inner temperature of the washing machine is maintained at a preset temperature, and for cutting off power supplied to the heat generating unit when a decrement of the heating value reaches a preset reference decrement.

In still another aspect of the present invention, there is provided a drying method of a washing machine comprising: detecting a decrement of a heating value of a heat generating unit of a washing machine during a drying mode; and cutting off power supplied to the heat generating unit when the detected decrement reaches a preset reference decrement.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a sectional view showing a drum type washing machine in accordance with the conventional art;

FIG. 2 is a block diagram showing a drying apparatus of a washing machine according to the present invention;

FIG. 3 is a view showing a correlation between a heating value of a heater and time, between an inner temperature of a drum of a washing machine and time, and between a dehumidification amount inside the drum of the washing machine and time in order to explain a drying method of a washing machine according to the present invention;

FIG. 4 is a flow chart showing a drying method of a washing machine according to the present invention;

FIG. 5 is a graph showing a first embodiment for controlling a phase of a voltage supplied to a heater installed at the drying apparatus according to the present invention; and

FIG. 6 is a graph showing a second embodiment for controlling a phase of a voltage supplied to the heater installed at the drying apparatus according to the present invention.

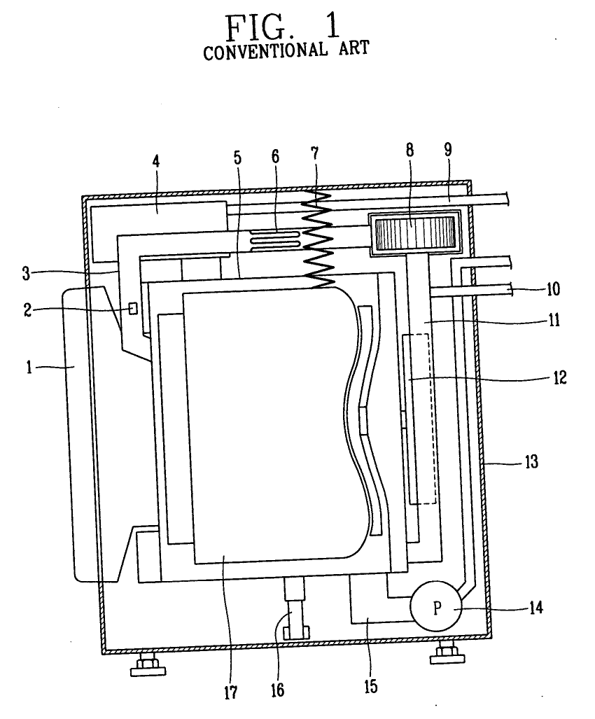

### DETAILED DESCRIPTION OF THE PREFERRED EMBODIMENTS

Reference will now be made in detail to the preferred embodiments of the present invention, examples of which are illustrated in the accompanying drawings.

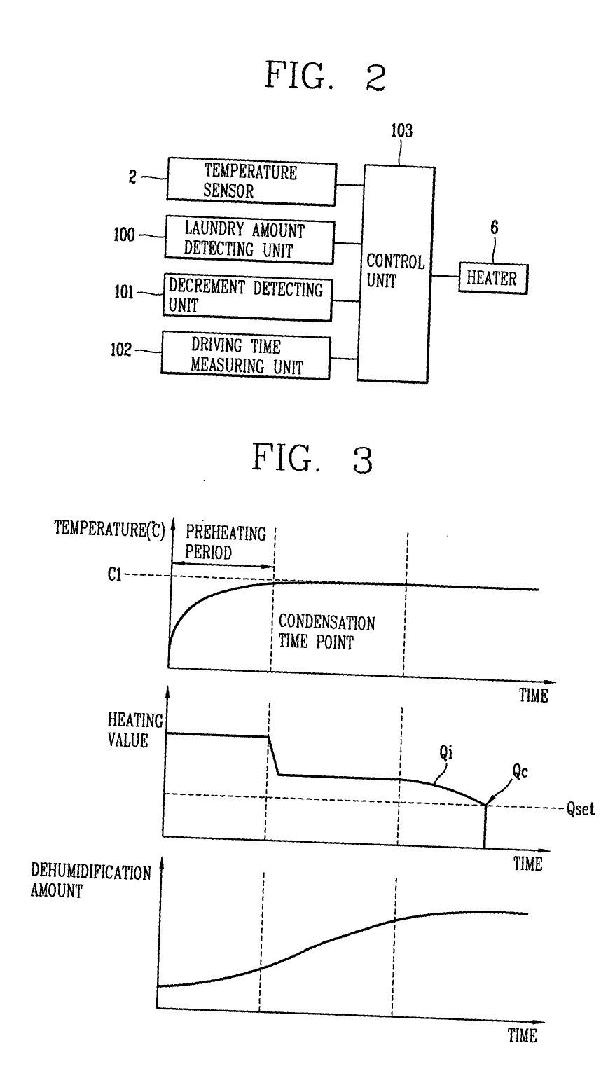

Hereinafter, with reference to FIGS. 2 to 6, a drying method will be explained with respect to a washing machine capable of precisely drying laundry and reducing power consumption by detecting a decrement or decrease of a heating value of a heat generating unit of the washing machine and cutting off power supplied to the heat generating unit when the detected decrement reaches a preset reference decrement, and an apparatus thereof.

FIG. 2 is a block diagram showing a drying apparatus of a washing machine according to the present invention.

As shown, the drying apparatus according to the present invention comprises: a decrement detecting unit 101 for detecting a decrement (Qᵢ) of a heating value of a heater 6 when the washing machine is in a drying mode to dry laundry by the heater 6; and a control unit 103 for controlling a heating value of the heater 6 so that an inner temperature of a drum 17 is maintained at a preset temperature C1 (for example, 120°) based on a temperature detected by a temperature sensor 2 installed in the drum 17 of the washing machine, and for cutting off power supplied to the heater 6 when the decrement (Qᵢ) detected by the decrement detecting unit 101 reaches a preset reference decrement (Qₛₑₜ) (for example, a value less than 50% of a maximum heating value (100%) of the heater). In the present invention, not only the heater 6 but also a heat generating unit of various types can be used.

The control unit 103 dries wet laundry by a maximum heating value of the heater when the washing machine is placed in a drying mode, and controls a heating value of the heater in order to maintain a preset temperature (for example, 120°) until laundry is completely dried. As time goes on, the more the laundry is gradually dried, the more a heating value of the heater is decreased. When laundry is completely dried, moisture of the laundry is almost removed and thereby a heating value of the heater 6 is drastically decreased. That is, when moisture of the laundry is almost removed, the heat consumed by moisture decreases. Accordingly, a preset temperature (for example, 120°) can be maintained even with a lower heating value (for example, a value less than 50% of a maximum heating value). Herein, the more a decrement of the heating value of the heater 6 is increased, the more a dryness degree (drying rate) of laundry is increased.

In the present invention, a decrement of a heating value of the heater 6 is detected, and when the detected decrement reaches a preset reference decrement, power supplied to the heater 6 is cut off, thereby precisely drying the laundry. Herein, the preset reference decrement is a value obtained by an experiment, and means a heating value of the heater 6 (for example, a value less than 50% of a maximum heating value (100%)) when laundry has been properly dried (for example, a drying rate more than 90%).

The control unit 103 can be implemented as, for example, a microcomputer in which a control program is mounted. Also, the control unit 103 controls a heating value of the heater 6 by controlling a phase of a voltage applied to the heater 6, rather than turning the heater 6 off and on, so that air circulated into the tub 5 through the circulation duct 3 can be maintained at a preset temperature (for example, 120°).

Hereinafter, operation of the drying apparatus of a washing machine according to the present invention will be explained with reference to FIG. 3. FIG. 3 is a view showing a correlation between a heating value of a heater and time, between an inner temperature of a drum of a washing machine and time, and between a dehumidification amount inside the drum of the washing machine and time in order to explain a drying method of a washing machine according to the present invention.

As shown, the heater 6 is operated with a maximum heating value in a preheating period so that a temperature inside the drum can reach the preset temperature C1 at the time of performing a drying process. A heating value of the heater 6 is initially drastically decreased at a condensation time that condensate water is supplied into a condensation duct 11. Then, the heater 6 maintains the decreased heating value uniformly for a certain time.

When the laundry reaches a dryness rate goal (for example, a value more than 90%) as the drying process is performed, a heating value of the heater 6 reaches a preset reference decrement. When a decrement of the heating value of the heater 6 reaches the preset reference decrement for a preset time after the condensation time point or is more than the preset reference decrement, the control unit 103 determines that the laundry has reached the dryness degree goal (Q_{c}). According to this, the control unit 103 cuts off power supplied to the heater 6, thus finishing the drying mode of the washing machine.

When a driving time measuring unit 102 is further installed at the washing machine, the driving time measuring unit 102 measures a driving time of the heater from a time point that the heating value of the heater is decreased and informs the control unit 103 of the measured driving time. If the measured driving time exceeds a preset time and the decrement of the heating value of the heater 6 reaches the preset reference decrement, the control unit 103 cuts off power supplied to the heater 6, thus finishing the drying mode of the washing machine. That is, with the driving time measuring unit 102, a driving time of the heater 6 is measured from a time point that the heating value of the heater 6 starts to decrease, thereby precisely detecting a decrement of the heating value of the heater 6.

When a laundry amount detecting unit 100 is further installed at the washing machine, the laundry amount detecting unit 100 detects a laundry amount inside the drum 17. Herein, the preset reference decrement is set according to the detected laundry amount. When a decrement of the heating value of the heater 6 reaches the preset reference decrement (Qₛₑₜ), the control unit 103 cuts off power supplied to the heater 6 thus to finish the drying mode of the washing machine. That is, laundry can be precisely dried according to a laundry amount detected by the laundry amount detecting unit 100.

In the present invention, the driving time measuring unit 102 and the laundry amount detecting unit 100 can be used in order to maximize the effect of the drying method of a washing machine.

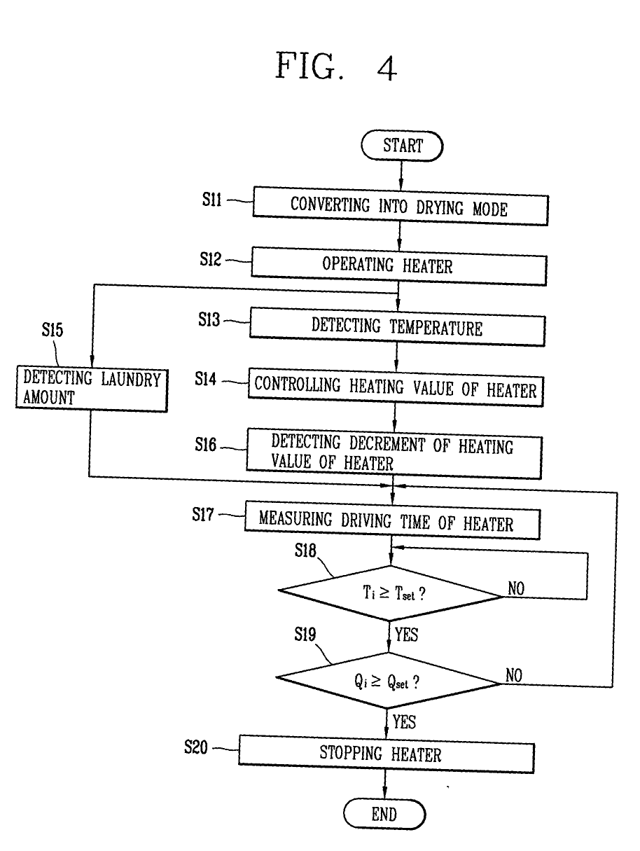

Hereinafter, operation of the drying apparatus of a washing machine according to one embodiment of the present invention will be explained with reference to FIG. 4.

FIG. 4 is a flow chart showing a drying method of a washing machine according to the present invention.

First, the control unit 103 converts a mode of the washing machine into a drying mode (S11), and operates the heater 6 so that an inner temperature of the drum 17 can quickly reach a preset temperature. That is, the control unit 103 controls the heater 6 so that a heating value of the heater 6 can be maximum (S12).

The control unit 103 detects an inner temperature of the drum 17 periodically transmitted from the temperature sensor 2 (S13), and can also detect a laundry amount transmitted from the laundry amount detecting unit 100. The method for detecting a laundry amount is the same as that of the conventional art, thereby its explanation is omitted.

The control unit 103 controls the heating value of the heater 6 with a voltage phase control method based on a temperature detected by the temperature sensor 2 so that the temperature inside the drum 17 can be maintained at the preset temperature (S14).

Then, the decrement detecting unit 101 periodically detects a decrement (Qᵢ) of the heating value of the heater 6 according to a control signal of the control unit 103 when the inner temperature of the drum 17 increases to the preset temperature and thereby condensing water is supplied into the condensation duct 11. Then, the decrement detecting unit 101 outputs the detected decrement Qᵢ of the heating value to the control unit 103 (S16). At this time, the driving time measuring unit 102 measures a driving time (Tᵢ) of the heater 6 from a time point when the heating value of the heater 6 starts to decrease under a control of the control unit 103 (S17).

When the detected decrement (Qᵢ) of the heating value is greater than or equal to the preset reference decrement (Qₛₑₜ), the control unit 103 cuts off power supplied to the heater 6. For example, if the measured driving time (Tᵢ) is greater than or equal to the preset time (Tₛₑₜ), the control unit 103 determines whether the increased decrement (Qᵢ) of the heating value of the heater 6 reaches the preset reference decrement (Qₛₑₜ) (S19). If the decrement of the heating value of the heater 6 reaches the preset reference decrement or is more than the preset reference decrement, the control unit 103 cuts off power supplied to the heater 6. When the decrement of the heating value of the heater 6 increases for the preset time (Tₛₑₜ) and is more than the preset reference decrement, the control unit 103 determines that the laundry has reached a drying rate goal and thereby cuts off power supplied to the heater 6 (S20).

Then, the control unit 103 rotates the drum 17 for a preset time and stops the driving of the drum 17, thereby completing the drying mode of the washing machine.

A method for controlling a phase of a voltage supplied to the heater 6 in order to maintain the temperature inside the drum 17 of the washing machine at the preset temperature will be explained in more detail.

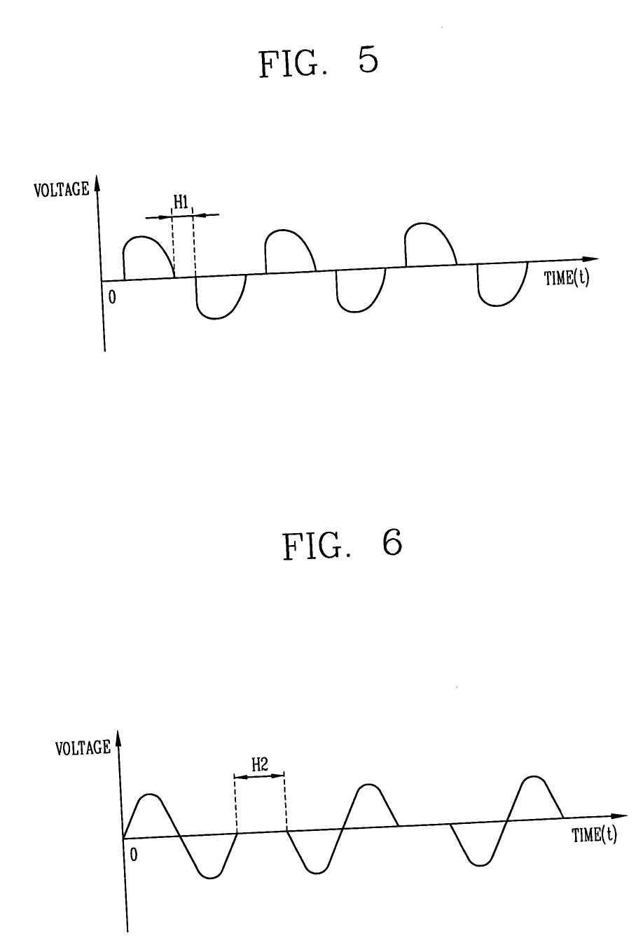

Hereinafter, the voltage phase controlling method will be explained in more detail with reference to FIGS. 5 and 6.

FIG. 5 is a graph showing a first embodiment for controlling a phase of a voltage supplied to the heater installed at the drying apparatus according to the present invention.

As shown, when a temperature in the drum 17 reaches the preset temperature, the control unit 103 controls a phase of a voltage having a sine wave supplied to the heater 6. That is, the control unit 103 controls a phase of a voltage supplied to the heater 6 by applying an opposite phase to a predetermined section of a voltage supplied to the heater 6 and thereby attenuating the phase of the predetermined section. For example, the control unit 103 controls a phase of a voltage supplied to the heater 6 by applying an opposite phase to a predetermined section HI per one period of the sine wave.

FIG. 6 is a graph showing a second embodiment for controlling a phase of a voltage supplied to the heater installed at the drying apparatus according to the present invention.

As shown, the control unit 103 controls a phase of a voltage supplied to the heater 6 by applying an opposite phase to a semi-period section H2 of two periods of the sine wave. Also, the control unit 103 can apply an opposite phase to a predetermined section among periods of an integer times of the sine wave. That is, the method for controlling a phase of a voltage supplied to the heater 6 can be variously performed.

If the inner temperature of the drum 17 is judged to have increased up to the preset temperature as the drying process is performed, the control unit 103 applies a voltage that is phase-controlled by an opposite phase to the heater 6 as shown in FIGS. 5 and 6 thereby to control the heater 6 so that the inner temperature of the drum 17 can be maintained at the preset temperature. For example, at the time of controlling the heater 6 with a maximum heating value, the control unit 103 applies a voltage to the heater 6 as it is, without attenuating a phase of the voltage. Also, at the time of decreasing the heating value, the control unit 103 attenuates a phase of a voltage of a predetermined section by an opposite phase_thereby to control a decrement of the heating value of the heater 6.

As aforementioned, in the drying method of a washing machine and the apparatus thereof according to the present invention, when the washing machine is in a drying mode, a decrement of the heating value of the heater is detected. When the detected decrement of the heating value of the heater reaches a preset reference decrement, power supplied to the heater is cut off to thereby precisely dry laundry without installing a sensor such as a dryness degree sensor.

Also, in the drying method of a washing machine and the apparatus thereof, the heater is not turned on and off. Instead, a phase of a voltage applied to the heater is controlled to thereby reduce power consumption.

Additionally, in the drying method of a washing machine and the apparatus thereof, a heating value of the heater is controlled by controlling a phase of a voltage applied to the heater, thereby reducing a drying time of laundry.

Also, in the drying method of a washing machine and the apparatus thereof, a phase of a voltage applied to the heater is controlled to thereby constantly maintain the inner temperature of the drum, thereby preventing laundry from being overheated or preventing a drying efficiency from being decreased.

Also, while the present invention has been described with respect to a washing machine having a drying mode, it is also within the scope of the present invention to apply to a drying machine (i.e., a dryer). Thus the term washing machine includes a dryer.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A drying method performed by a washing machine comprising:
drying laundry with a heater installed in the washing machine during a drying mode;
detecting a decrement of a heating value of the heater; and
cutting off power supplied to the heater when the detected decrement reaches a preset reference decrement.

2. The method of claim 1, wherein in the drying laundry, the laundry is dried by controlling a phase of a voltage applied to the heater such that an inner temperature of a drum of the washing machine is maintained at a preset temperature.

3. The method of claim 1, wherein the preset reference decrement is a heating value of the heater when the laundry is in a dried state.

4. The method of claim 1, wherein the preset reference decrement is based on the amount of laundry, and is a heating value of the heater when laundry is completely dried.

5. A drying method performed by a washing machine comprising:
detecting a temperature by a temperature sensor inside a washing machine when the washing machine is in a drying mode;
maintaining an inner temperature of the washing machine at a preset temperature by a heater based on the detected temperature;
detecting a decrement of a heating value of the heater; and
cutting off power supplied to the heater when the detected decrement is more than a preset reference decrement (said preset reference decrement being related to a drying rate goal).

6. The method of claim 5, wherein in the step of cutting off power supplied to the heater, power supplied to the heater is cut off when the decrement of the heating value of the heater is increased and the increased decrement reaches the preset reference decrement.

7. The method of claim 5, wherein in cutting off power supplied to the heater, a driving time of the heater is measured from a time point that the heating value of the heater starts to decrease, and when the driving time exceeds a preset time and the decrement of the heating value of the heater reaches the preset reference decrement, power supplied to the heater is cut off.

8. The method of claim 5, wherein the preset reference decrement is further related to the amount of laundry, and is a heating value of the heater when laundry is completely dried.

9. The method of claim 5, wherein in the maintaining an inner temperature of the washing machine at a preset temperature by a heater, a heating value of the heater is controlled by controlling a phase of a voltage supplied to the heater.

10. A drying apparatus of a washing machine comprising:
a decrement detector that detects a decrement of a heating value of a heater installed in a washing machine; and
a control unit that controls a heating value of the heater such that an inner temperature of the washing machine is maintained at a preset temperature based on a temperature detected by a temperature sensor installed in the washing machine, and for cutting off power supplied to the heater when a decrement of the heating value reaches a preset reference decrement.

11. The apparatus of claim 10, further comprising a driving time measuring unit that measures a driving time of the heater from a time that a heating value of the heater starts to decrease, wherein the control unit cuts off power supplied to the heater when the measured driving time exceeds a preset time and the decrement of the heating value of the heater reaches the preset reference decrement.

12. The apparatus of claim 10, wherein the preset reference decrement is related to the amount of laundry, and is a heating value of the heater when laundry is completely dried.

13. The apparatus of claim 10, wherein the control unit controls a heating value of the heater by controlling a phase of a voltage supplied to the heater.

14. The apparatus of claim 10, wherein the control unit maintains an inner temperature of a drum of the washing machine at a preset temperature by controlling a phase of a voltage supplied to the heater.

15. The apparatus of claim 10, wherein the control unit controls a phase of a voltage supplied to the heater by attenuating a phase of a predetermined section of a voltage supplied to the heater.

16. A drying apparatus of a washing machine comprising:
a detector that detects a decrement of a heating value of a heat generating unit of a washing machine; and
a control unit for controlling the heating value such that an inner temperature of the washing machine is maintained at a preset temperature, and for cutting off power supplied to the heat generating unit when a decrement of the heating value reaches a preset reference decrement.

17. A drying method performed by a washing machine comprising:
detecting a decrement of a heating value of a heat generating unit of a washing machine during a drying mode; and
cutting off power supplied to the heat generating unit when the detected decrement reaches a preset reference decrement.
